(19) United States
(12) Patent Application Publication
(10) Pub. No.: US 2006/0081141 A1
(43) Pub. Date: Apr. 20, 2006

(54) Printing press ink supply system for thixoptropic inks

(76) Inventor: P. Kenneth Deneka, Cream Ridge, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/967,380

(22) Filed: Oct. 18, 2004

(51) Int. Cl. B41F 31/02

(52) U.S. Cl. 101/366

(57) ABSTRACT

An ink supply system for a printing press for thixotropic inks includes a coating head having a chamber open to a coating cylinder. The chamber includes a supply zone, a return zone and a pressure zone and having a small volume such that all ink contained in the zones is kept in constant motion. A container with an agitator and an exit port is provided. A first pump supplies ink from ink container to the supply zone and a second pump returns ink from the return zone of the chamber to the container. The pumps provide movement and increased pressure to substantially all ink within the chamber.

### BACKGROUND OF THE INVENTION

The present invention pertains to the art of printing and printing presses and, more particularly, to an improvement in a printing press having a device for supplying ink or other liquid to a coating cylinder.

Food packaging, cartons, containers, periodicals, newspapers, and other like items are commonly printed by means of flexographic or gravure roll printing presses. Materials used in some of these applications are constructed of multiple layers which are laminated using adhesives and coatings applied by gravure roll application. Devices in current use to supply ink or adhesive or coating to a coating cylinder in such a press or coater/laminator, or the like, typically have a metal body to which clamps are used to hold in place flexible thin blades which contact the surface of the coating cylinder over its entire length. With the length of the prior coating head device oriented along the long center line axis of the coating cylinder, the flexible blades form a liquid seal in the axial direction. At the ends of the device are seals cut to an appropriate shape and clamped at the end to form a liquid seal at each end of the device. The device is then pressed to the radial surface of the coating cylinder and a liquid seal is achieved. These prior devices are known generically in the art as a dual enclosed doctor blade system. A dual enclosed doctor blade system typically has two or more flexible blades, end seals and use a means to circulate liquid through the device.

Several patents teach printing coating head devices. For example, U.S. Pat. Nos. 5,988,064 (Deneka) and U.S. Pat. No. 5,826,509 (Deneka) are directed to a printing coating head device for coating an engraved surface on a coating cylinder of a printing press having a main body with a longitudinal cavity for liquid, open to the coating cylinder and substantially sealable to the coating cylinder. The cavity has an injection zone providing for a zone pressurizing the liquid within a portion of the cavity in the main body to compel liquid into cells in the engraved surface of the coating cylinder. The main body has an inlet to provide liquid to the supply chamber and a return to exhaust liquid from the outlet section.

U.S. Pat. No. 6,201,757 (Taylor et al.) is directed to an enclosed printing coating head device particularly designed for applying pressure sensitive films to web-type substrates. A downstream blade and an arcuately spaced upstream blade are positioned with respect to a roll to be coated. An intermediate gap-forming body between the blades forms a running gap with the surface of the roll to be coated. Substantially air free liquid coating is applied under pressure to an offrunning chamber adjacent the offrunning blade with excess coating flowing through the gap to an onrunning chamber adjacent the upstream blade. The pressure in the onrunning chamber is regulated at a relatively constant positive value sufficient to prevent air from entering the onrunning chamber past the upstream blade.

One type of ink in which was introduced for commercial use about twenty five years ago is electron beam curable ink. Upon exposure to an electron beam, electron beam curable inks link their polymers with high energy electrons. This provides a glossy surface that has excellent wear and tear properties and abrasion resistance.

The electron beam curable inks instantaneously cure upon exposure to the electron beam. The electron beam apparatus is located in-line and after the engraved roll found in flexographic and gravure printing presses. The present invention pertains to printing of certain new ink formulations such as electron beam curable inks, having very desirable properties such as high color density, excellent dot formation characteristics, water and moisture resistance, scuff resistance, substantial laminating adhesive characteristics that are capable of printing wet ink on top of wet ink—a property referred to as “wet trapping”—and are not dried but are rather cured by a high energy source such as an electron beam. Such inks have a notable water content prior to being cured where the water remains in the ink after curing and therefore no emissions result from the curing of the ink. Further, such inks have no photo-initiators. Because of the water content, such inks have the capacity to absorb and retain small amounts of air resulting in micro foam. This micro foam causes the ink volume to expand and substantially raises the fluid viscosity to a point where viscosity is no longer measurable by any easy normal means, the fluid properties change substantially and become highly thixotropic. In any chamber of common design, the thixotropy of the ink rises to a point where it becomes a gel and causes a variety of problems such as massive leaking out of the chamber and therefore effectively ends the viability of further continuation of printing. It is a goal of this invention to provide a means of allowing this ink to be processed on a continual basis far longer than can be achieved by any other known means.

All references cited herein are incorporated herein by reference in their entireties.

### BRIEF SUMMARY OF THE INVENTION

An ink supply system for coating an engraved surface of a coating cylinder of a printing press with an ink having high thixotropic fluid characteristics is provided. The system includes a printing coating head, an ink container, and a pair of pumps. The main body of the printing coating head has a longitudinal chamber for liquid that extends for a length parallel to a longitudinal axis of the coating cylinder and which is open to the coating cylinder. The printing coating head has a seal to substantially seal the main body to the coating cylinder. The chamber includes a supply zone, a return zone, and a pressure zone. The supply zone provides for ink distribution across the entire longitudinal chamber and has a surface spaced from the engraved surface of the coating cylinder. The supply zone has a sufficiently small volume such that substantially all ink contained in the supply zone during operation of the ink supply system is kept in constant motion. The return zone has a surface spaced from the engraved surface of the coating cylinder, the return zone having a sufficiently small volume such that substantially all ink contained in the return zone during operation of the ink supply system is kept in constant motion. The pressure zone has a face located substantially closer to the engraved surface than the surfaces of the supply zone and the return zone. The main body of the printing coating head has an inlet to provide liquid to the chamber and an outlet to provide for liquid and air to move out of the return zone of the chamber. The system also includes an ink container having an agitator disposed therein and an exit port at the bottom of the container. A first pump supplies ink from the ink container to the supply zone of the chamber. A second pump returns ink from the return zone of the chamber to the ink container. The first pump and the second pump provides movement and increased pressure to substantially all ink within the chamber. Substantially all ink within the system is kept at an increased pressure relative to ambient pressure and moving at all times to prevent substantially all stagnation of the ink within the system.

Preferably, the face of the pressure zone is located less than about 0.25 inches from the surface of the engraved roll. More preferably, the face of the pressure zone is located between about 0.140 inches and about 0.050 inches from the surface of the engraved roll. The system operates most effectively when the agitator extends to substantially the entire inside perimeter of the container. Preferably the agitator is of a propeller or blade type design having blades where the blades extend to the inside perimeter of the container. The rotational speed of the agitator is preferably about fifty and to one hundred fifty revolutions per minute and is sufficiently low to prevent cavitation of the ink.

Preferably, the supply zone is adapted to provide for ink distribution across the length of the longitudinal chamber where the surface of the supply zone is semi-circular in cross section and perpendicular to the length of the longitudinal chamber and the surface is spaced from the engraved surface of the coating cylinder. Additionally, preferably, the return zone is adapted to receive ink from the pressure zone and is disposed parallel to the supply zone. The surface of the return zone is preferably semi-circular in cross section and perpendicular to the length of the longitudinal chamber, and is spaced from the engraved surface of the coating cylinder.

In a preferred configuration, the volume of the chamber is about 200 to 700 milliliters per meter of chamber length. More preferably, the volume of the chamber is about 300 to 400 milliliters per meter of chamber length. Most preferably, the volume of the chamber is about 350 milliliters per meter of chamber length.

Finally, preferably, the first pump and the second pump are positive displacement pumps.

### BRIEF DESCRIPTION OF SEVERAL VIEWS OF THE DRAWINGS

The invention will be described in conjunction with the following drawings in which like reference numerals designate like elements and wherein:

FIG. 1 is a simplified, schematic, side elevation view of a printing press upon which an ink supply system in accordance with the present invention is used;

FIG. 2 is a partial, magnified, cutaway view of the engraved surface of a coating cylinder as used on the printing press of FIG. 1, taken substantially along lines 2- -2 of FIG. 1;

FIG. 3 is a simplified, side elevation view of an ink supply system for a printing press in accordance with a preferred embodiment of the present invention;

FIG. 4 is an isometric view of a preferred printing head of the ink supply system of FIG. 3;

FIG. 5 is a cross-sectional side elevation view of a preferred coating head device of the ink supply system of FIG. 3, taken substantially along lines 5- -5 of FIG. 4.

FIG. 6 is a simplified cross-sectional, side elevation view of a prior art coating head device;

FIG. 7 is a simplified cross-sectional, side elevation view of an alternate coating head device;

FIG. 8 is a simplified cross-sectional, side elevation view of another alternate coating head device;

FIG. 9 is a simplified cross-sectional, side elevation view of yet another alternate coating head device;

FIG. 10 is a simplified cross-sectional, side elevation view of still another alternate coating head device; and

FIG. 11 is a simplified cross-sectional, side elevation view of yet another alternate coating head device.

### DETAILED DESCRIPTION OF THE INVENTION

The present invention is directed to flexographic and gravure printing presses upon which it is desired that thixotropic inks be used. The invention uses a printing coating head that has an enclosed chamber in which the cavity of the chamber is exceedingly small in volume relative to chambers currently known and where the arrangement is such that it allows ink to be distributed across the full face length of the engraved coating cylinder. The chamber is further arranged to assure that all fluid within the chamber is kept in motion and under suitable pressure to assure the thixotropic ink is constantly being sheared so as to keep the fluid viscosity low enough to allow the liquid to effectively and uniformly fill the small cells of the engraved surface of the coating cylinder and to continue to do so despite continued micro foaming of the ink and loss of water due to evaporation from the surface of the engraved coating cylinder.

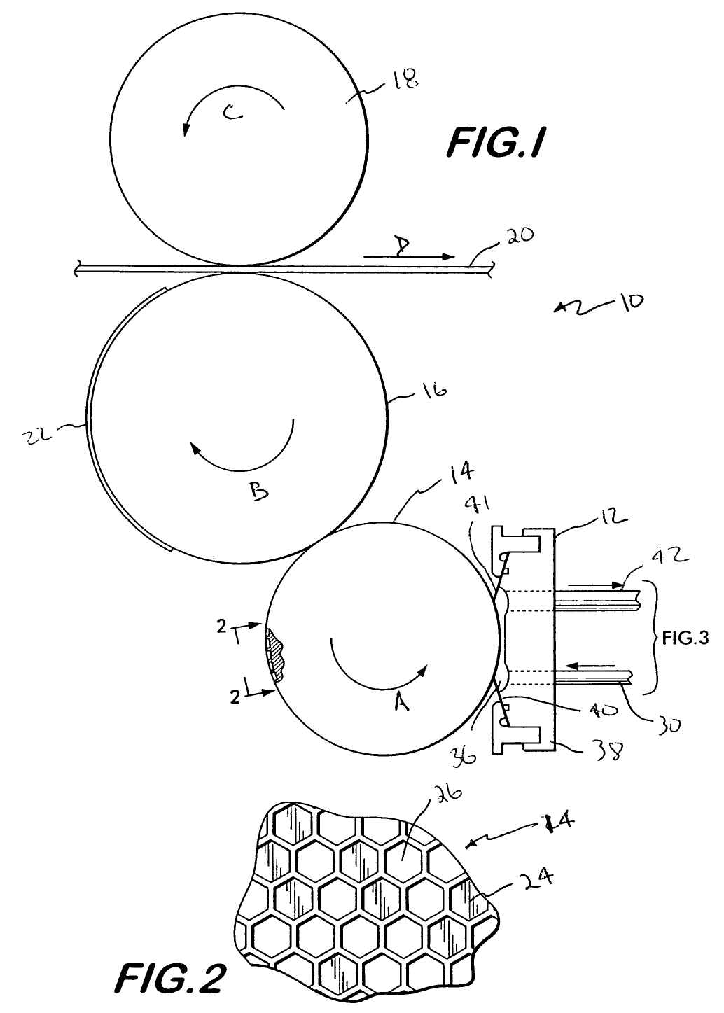

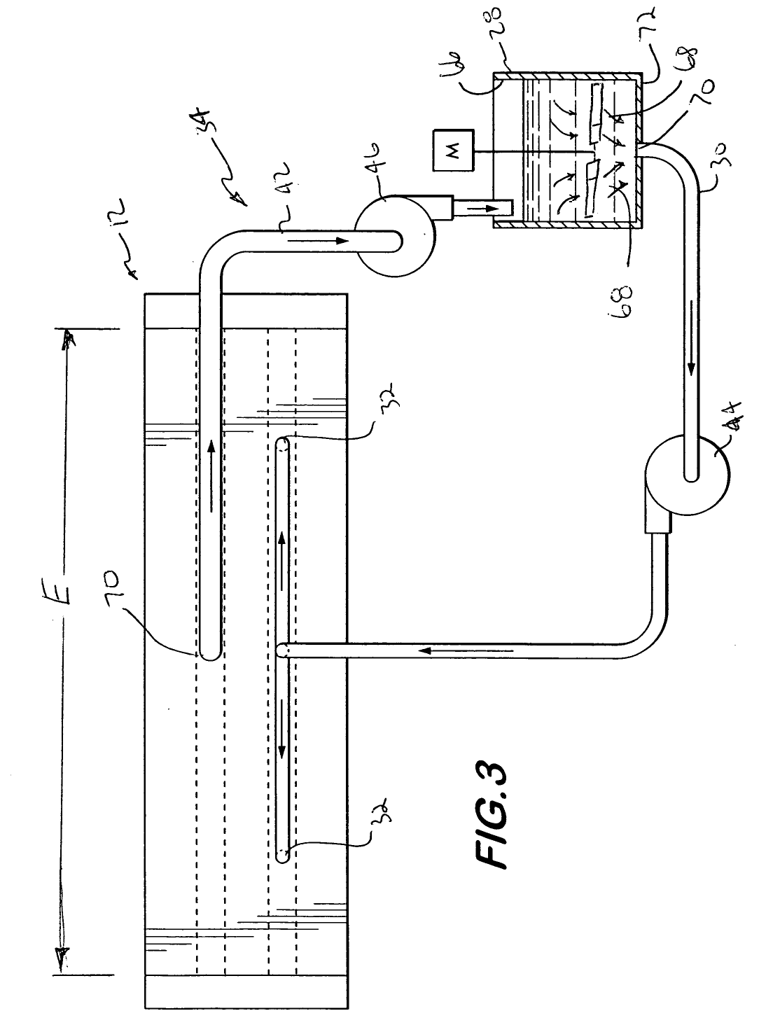

Referring now in detail to the drawings, wherein like reference numerals indicate like elements throughout the several views, there is shown in FIG. 1, a printing station 10 in accordance with a preferred embodiment of the present invention in simplified form. The printing station 10 of the present invention may be a conventional flexographic printing station, or any other printing station wherein a coating head 12 is used in conjunction with an anilox roll, gravure cylinder, or other ink applicator roll, hereinafter referred to as coating cylinder. As seen in FIG. 1, a conventional flexographic printing station has a printing cylinder 16 (or plate cylinder) and a backing cylinder 18 between which sheets of, or continuous roll fed substrate, for example, paper 20, are sequentially advanced. A printing plate 22 is mounted on the printing cylinder 16, for example, by adhesive. As can be seen in FIG. 1, as coating cylinder rotates in direction A, the printing coating head 12 applies a liquid such as ink to the coating cylinder 14 which has an engraved surface 24 (see FIG. 2). Preferably, the printing coating head 12 is installed on the coating cylinder 14 at either the three o'clock or nine o'clock positions. The ink or other liquid is provided to cells 26 in the engraved surface 24 of the coating cylinder 14 for holding liquid to be transferred to the printing plate 22. The ink is supplied to the coating cylinder 14 by the printing coating head 12. As can best be seen in FIG. 1 in combination with FIG. 3, the ink or other liquid is supplied to the printing coating head 12 from ink container 28 through liquid supply pipe 30 to inlet orifices 32 of the printing coating head 12.

Coating cylinders 14 with different engraved surfaces 24 (also called surface screens) are available, e.g. surfaces formed with small pyramids, or quadrangles, or hexagonal shapes, or having channels therein, etc. The present invention will operate under a wide variety of these surfaces. These different engraved coating cylinders may provide different printing qualities. In the preferred embodiment, the engraved surface 24 is of a hexagonal configuration. These engraved surfaces may be, for example, laser engraved at, for example 700 lines per lineal inch. The surface may also be chrome plated to provide for corrosion resistance.

FIG. 1 depicts a vertical elevation view of printing station 10 and shows a preferred arrangement of the main relevant operating elements required for the present invention.

At the top is the backing cylinder 18 which cooperates with the printing cylinder 16 having mounted thereon printing plate 22. The cylinders 14 and 16 rotate respectively in the direction of arrows A and B to feed the sheet of paper 20 therebetween in the direction of the arrow D with the paper 20 being printed on the underside thereof. The coating cylinder 14 is rotated counterclockwise in the direction of the arrow A and inks the printing plate 22. Ink is supplied to the surface of the coating cylinder 14 via the printing coating head 12 of the current invention.

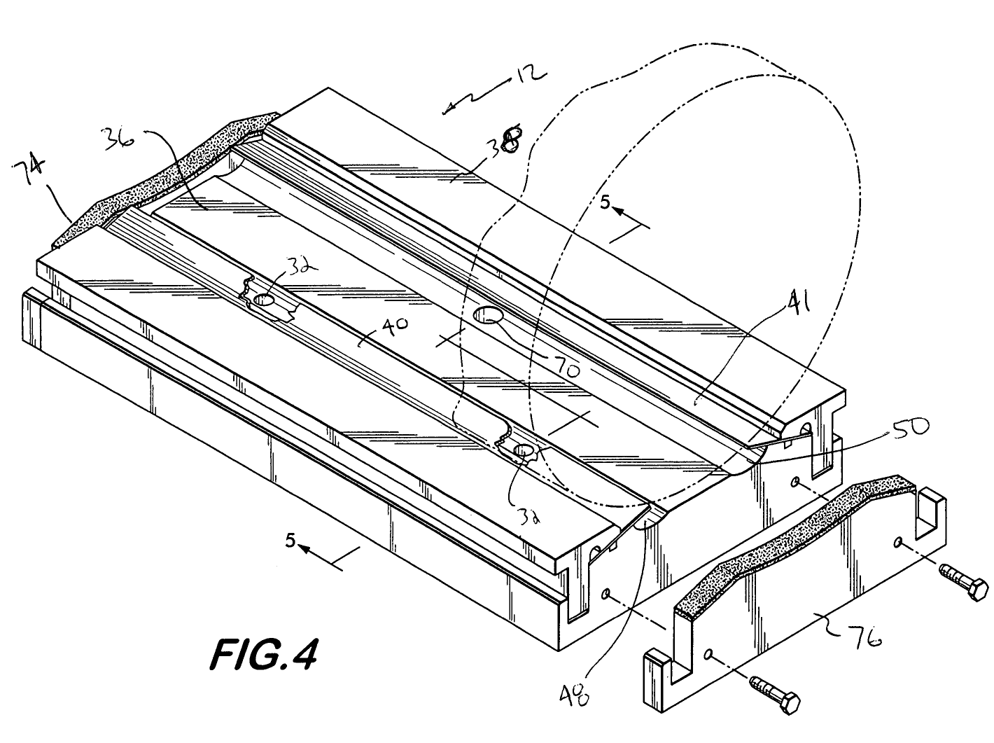

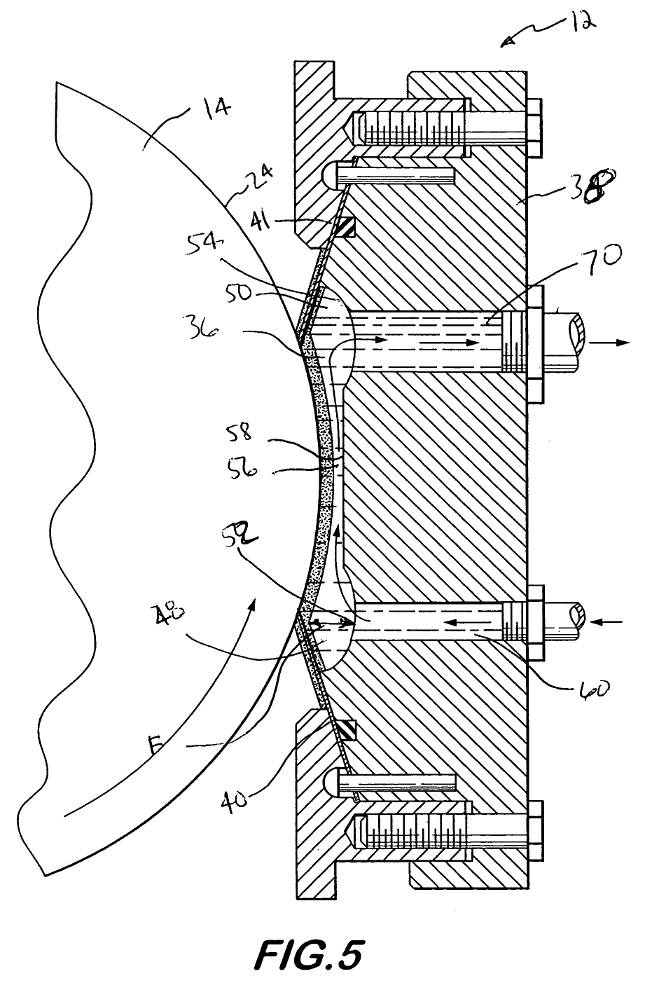

FIG. 3 depicts an ink supply system 34 for coating the engraved surface 24 of the coating cylinder 14 of a printing press (station 10) with an ink having high thixotropic fluid characteristics in accordance with a first preferred embodiment of the present invention. As best seen in FIGS. 4 and 5, the ink supply system 34 includes the printing coating head 12 that includes a main body 38 having a longitudinal chamber 36 for liquid open to the coating cylinder 14 and having seals (doctor blades 40, 41 and seal plates 74, 76) to substantially seal the main body 38 to the coating cylinder 14. As can be seen in FIGS. 1, 4, and 5, lead doctor blade 40 clears the engraved surface 24 and breaks the boundary layer of air that impedes cell-filling. Liquid (ink) is substantially contained within the printing coating head and associated tubing, including liquid supply pipe 30, liquid return pipe 42, pumps 44, 46 (discussed below), and ink recirculation container 28.

As best seen in FIGS. 4 and 5, the chamber 36 includes a supply zone 48 to provide for ink distribution across the entire longitudinal chamber 36. The supply zone 48 has a surface 52 (see FIG. 5) spaced from the engraved surface 24 of the coating cylinder 14 and has a sufficiently small volume such that substantially all ink contained in the supply zone 48 during operation of the ink supply system 1 is kept in constant motion.

A return zone 50 also has a surface 54 (see FIG. 5) spaced from the engraved surface 24 of the coating cylinder 14 and has a sufficiently small volume such that substantially all ink contained in the return zone 50 during operation of the ink supply system 34 is kept in constant motion. A pressure zone 56 having a face 58 is also provided that is located substantially closer to the engraved surface 24 than the surfaces 52, 54 of the supply zone 48 and the return zone 50. The main body 38 has at least one inlet 32 to provide liquid to the supply zone 48 of the chamber 36. The main body 38 also has at least one outlet 62 to provide for liquid and air to move out of a return zone 50 of the chamber 34.

As seen in FIG. 3, the ink container 28 is provided for supplying ink to the chamber 34 of the printing coating head 12. Within the ink container 28, an agitator 64 is provided to keep substantially all of the ink disposed in the container 28 in motion. Preferably, the agitator 28 is in the form of blades 68 that extend to substantially the entire inside perimeter 66 of the ink container 28. An agitator 64 design that has been found to operate satisfactorily is an impeller type design having blades 68. However, it is noted that any of a variety of known agitator configurations will also likely operate satisfactorily.

The impeller geometry impeller blades 68 are preferably of any design that reach to the wall of the container with a small (for example, one quarter inch to one half inch) clearance. It can be a propeller-like shape, straight blade shape or any other shape. The preferred geometry is a flat blade with a twenty degree bend forward toward the direction of rotation at about two-thirds of the distance from the shaft to the side of the container and with a slight (two degree to five degree) downward tilt and with a height of at least one quarter the height of the container and where the combination of these elements create a steady movement of the fluid and a forward and downward pressure of the ink into the bottom of the container.

The agitator also may be, for example, a shaker, however, it is likely that this would be a noisy method and have a tendency to produce splashing. The agitator may a vibrating type agitator. However, here noise again may be an issue and the vibrator(s) will likely have to be immersed in the fluid at one or more places to be effective thereby creating a cleaning problem along with the other drawbacks. The agitator may be in the form of a pressurized container. However, such a container may not allow air to escape from the ink which will accelerate the process of forming micro-foam and viscosity “build”. It is clear the use of an impeller is the reasonable course to take.

An exit port 70 at the bottom 72 of the container 28 is also provided along with the liquid supply pipe 30 for supplying ink from the container 28 to the chamber 34. A first pump, inlet pump 44 is also provided to supply ink from the ink container 28 to the supply zone 48 of the chamber 36. A second pump, return pump 46, is provided to return ink from the return zone 50 of the chamber 36 back to the ink container 28. By using the inlet pump 44 and the return pump 46, movement and increased pressure is provided within the system such that substantially all ink within the chamber 36 is kept in constant motion. By using the pumps 44, 46 as well as the agitator 64, substantially all ink within the entire ink supply system 34 is kept at an increased pressure relative to ambient pressure and moving at all times to prevent substantially all stagnation of the ink within the entire ink supply system 34.

To operate effectively, the face 58 of the pressure zone 56 is preferably located less than about 0.25 inches from the engraved surface 24 of the coating cylinder 14. More preferably, the face 58 of the pressure zone 56 is located between about 0.140 inches and about 0.050 inches from the engraved surface 24 of the coating cylinder 14.

In a particularly preferred embodiment, the agitator 64 has a rotational speed of between about fifty and one hundred fifty revolutions per minute. However, so long as there is substantially no cavitation of the ink, other agitator speeds would also likely operate satisfactorily.

It has been found that the chamber 36 may be of a single cavity design (i.e., not having a defined supply zone and return zone) if the back of the cavity is less than about 0.375″ from the engraved surface 24 of the coating cylinder 14. See FIG. 7. However, it has been found that distribution of the ink across the entire cavity may be problematic in such single cavity chambers and therefore a three zone design, as discussed in the various embodiments herein, is preferred.

In the preferred embodiment of the present invention as seen in FIGS. 4 and 5, the supply zone 48 allows ink distribution across the entire printing coating head 12 (i.e., the dimension longitudinally across the engraved surface 24 of the coating cylinder 14), the pressure zone 56 has a broad face 58 and allows for a substantial “wedge” that causes a hydraulic pressure in the pressure zone 56 to be increased upon the ink. The non-Newtonian ink is then compressed and forced into the cells 26 of the engraved surface 24 of the coating cylinder 14. Air contained in the ink is pressed out of the ink layer against the engraved surface 24 such that the cells 26 contain substantially only ink, thus allowing for continued color density uniformity to be realized in spite of the continual change in ink fluid properties.

The three zone chamber 36 is preferably designed such that the pressure zone 56 is within 0.250″ from the engraved surface 24 of the coating cylinder 14 and, in the preferred design, is within 0.140″ to 0.050″ from the engraved surface 24 of the coating cylinder 14. The chamber 36 design has one or more supply ports (inlet orifices 32) to allow introduction of the ink and one or more exit ports 70 to allow for return of the ink to the container 28. The arrangement of the ports 32, 70 is sufficient to provide for full distribution across the coating cylinder 14 (dimension E of FIG. 3) and for adequate return of ink. Substantially the entire volume of the chamber 36 is arranged such the ink contained therein is kept in constant motion by the force of the pumps 44, 46 and the rotation of the engraved surface 24 of the coating cylinder 14 turning within the boundaries of the chamber 36.

The volume of the chamber 36 is substantially less than that of presently used printing heads. Preferably, the volume of the chamber is about 200 milliliters to 700 milliliters per meter of chamber length. More preferably, the volume of the chamber is about 300 to 400 milliliters per meter of chamber length. It has been found in testing performed to date that the most preferable chamber volume is about 350 milliliters per meter of chamber length. Conventional chambers generally available in the market today have volumes of 2000-5000 millimeters per meter of chamber length. The chamber volume of the present invention is therefore substantially smaller than that of conventional chambers.

It is preferred to use the two pumps 44, 46 to extend the viability of the printing function when using thixotropic inks. Significantly greater positive force is necessary to keep the ink in motion once micro foaming occurs. The normal method in the art of using a single pump for supply of ink to a chamber and returning ink to a container by means of gravity proves to be inadequate.

It is desirable to use pumps 44, 46 of such design that the push/pull characteristics can be carefully controlled so as to keep the flow through the chamber 36 carefully balanced. If there is too much flow caused by the pumps 44, 46, leaking will result and if there is too little flow created by the pumps 44, 46, “starvation” of ink on the engraved surface 24 will occur. It is therefore desirable to use pumps 44, 46 that have uniform volume pumping characteristics that are insensitive to variation in the force necessary to move a given volume in a uniform manner. Positive displacement pumps are most preferred, with mechanical pumps such as internal gear pumps, external gear pumps, progressing cavity pumps, rotary vane pumps being preferred. Peristaltic pumps can be used effectively however the cost of replacement hoses in the pump head can become prohibitively expensive and the variations in hose performance are difficult to keep up with because individual hoses lose elasticity and therefore pumping effectiveness at variable rates. Particularly preferred pumps are the internal gear rotary pumps made by the Varisco Group of Padova, Italy. For “wide web” flexographic printing (e.g., 30 inch to 70 inch wide), the Varisco V12 pump has been found to provide satisfactory results. The V12 pump is a one half inch pump with a capacity of 0.89 m³/h, a maximum pressure of 20 bar and an RPM of 1450.

As stated above, it is necessary to keep the full volume of ink in the ink supply/return container 28 constantly moving. The agitator 64 with blades 68, vanes or similar devices must extend to the inside perimeter of the container and be sufficiently sized to keep all fluid in motion. High speed is not required. In general, a rotational speed of fifty to one hundred fifty revolutions per minute is sufficient. Speed must be low enough to prevent cavitation of the fluid. An additional need for constant motion of the fluid is to prevent air from “worm holing” through the fluid and thereby allowing an air stream direct access to the suction port which can result in defects in printing or coating that look like those caused by “starvation”. This is most important for ink that has under gone processing for some amount of time. Full diameter stirring of the container (i.e., a round container) is necessary to keep these inks and compounds fluid and able to be circulated and otherwise processable.

For the purposes of the present invention, the term “chamber” and the term “cavity” are used interchangeably and refer to the volume that extends between the doctor blades 40, 41 (as will be described below), the engraved surface 24 of the coating cylinder 14 that is located between the doctor blades 40, 41, and seal plates 74, 76 that are located at each end of the printing coating head. See FIGS. 4 and 5.

The unifying element to this invention is that every component in the fluid processing stream must be arranged such as to keep the fluids (i.e., the inks) under pressure and moving at all times. A stagnation period of more than a few seconds may allow them to become a solid-like gel that will not move without substantial pressure and force. When the fluids are aerated to the point of becoming a gel, they also develop an adhesive-like property requiring considerable additional horsepower for the continued rotation of the coating cylinder 14. This additional force has been determined to be about one to one and one-half horsepower across a coating cylinder 14 having a 1.5 meter width. Therefore, the clearances required in the chamber are relatively small as compared to any typical ink or compound. The pumps found to be most effective are likewise not otherwise found in the flexographic printing business or gravure coating/printing business.

One specific ink that benefits from the ink supply system 34 of the present invention is Sun Chemical, Inc.'s UniQure energy (electron beam) curable inks. Electron beam curing is similar to ultraviolet curing. Electron beam curing units instantly link the polymers of the inks and coatings by using streams of high energy electrons. The electron beam curing units are installed in-line after the coating cylinder. Black UniQure ink includes a proprietary acrylate oligomer, alkyl acrylate ester, a proprietary acid acrylate half ester, a proprietary acrylate ester # 1, and water and has a density of about 9.96 lbs. per gallon. and a boiling point of 212 degrees Fahrenheit.

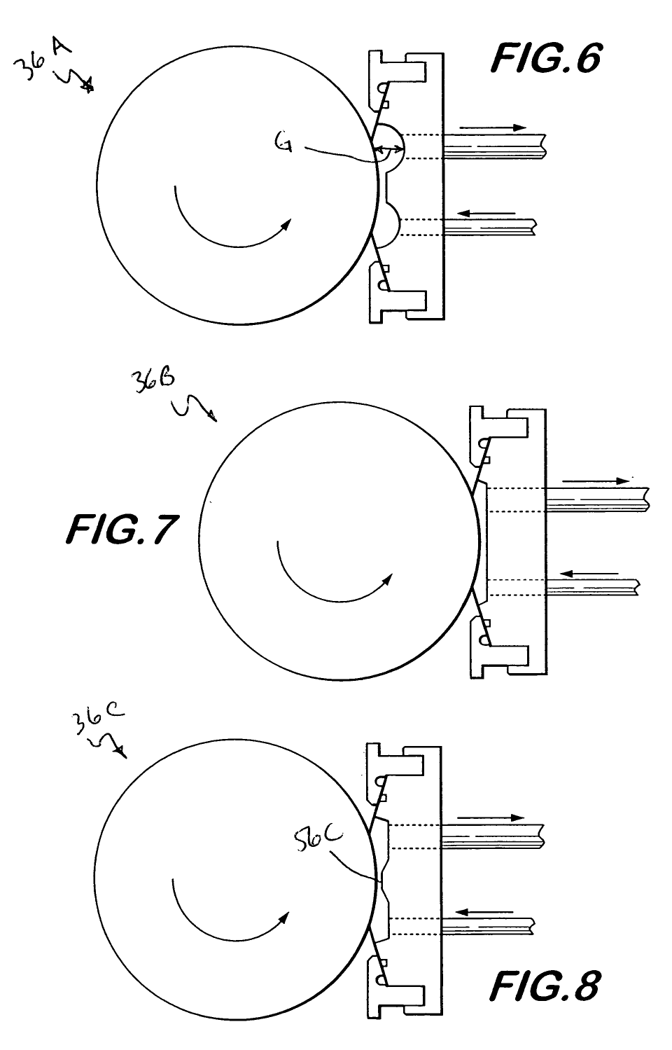

The preferred chamber 36 shape of the present invention is shown in the cross section of the printing coating head 14 of FIG. 5. This cavity here is a very small volume cavity structured to allow substantially the full volume of the cavity to be in motion either because of new fluid introduction (by means of inlet pump 44), the active circulation driver effect of the turning engraved surface 24 of the coating cylinder 14 within the chamber 36 or the suction force of a return (exhaust) pump 46. The slightly deeper cavity depth F of the supply zone 48 of the chamber 36 over the cavity depth G of a prior art chamber (for example, chamber 36A as shown in FIG. 6 and described below) allows for distribution of fluid across the face width of a coating cylinder and retards “starvation”. This restrictive geometry in concert with the active forces, keeps the fluid moving at levels above the minimum shear rates of a broad range of ink colors.

Pigments used in producing black and yellow colors are known to be more difficult to process than those generally found in colors such as magenta or cyan. Mixed colors made up of various combinations of the primary colors sometimes show tendencies to separate due miscibility problems, ionic forces etc. The ink supply system 34 of the present invention has been demonstrated to allow inks to mix well within the chamber 36 and deliver uniform color values and densities. Thixotropic inks behave well in this chamber 36 have functionally survived stress testing at speed of 800 feet per minute for as long as twenty-one hours using about three gallons of ink in the tank. No objectionable anomalies were noted in this test. It was noted that the power to keep a one meter wide anilox roll at 800 feet per minute required an additional one-half to three-quarter horsepower equivalent. This additional power requirement is due to changes in the overall rheology of the fluid in which the fluid developed some adhesive like qualities and increase in apparent viscosity.

The broad flat face of the pressure zone 58 of this preferred printing coating head 12 provides for substantial compression of the fluid stream, a desirable property for the fluids and inks after they have undergone some aeration and become non-Newtonian. Ink density appears to increase across this flat face 58 and allows more pure fluid to be pressed into the cells 26.

Another advantage to the chamber 36 of this coating head 12 is that the active flow paths throughout the chamber 36 allow for enhanced cleaning of the chamber 35. This chamber 36 is the easiest to flush clean using appropriate solutions and solvents. In a commercial environment, quick cleaning for color changes is quite important. Conventional chambers (discussed below and seen, for example, in FIG. 6) are typically extremely difficult to flush clean. High pressure sprays and high pressure flood washing will work, however significant leaking problems can be expected to occur.

An example of a typical prior art three-zone chamber 36A is shown in FIG. 6. Here, a fluid processed in this geometry quickly develops foaming and leads to substantial increases in “body” (hereafter referred to as “ageing”). At speeds of about 800 feet per minute and after about 30-40 minutes, the fluid has aged enough to become essentially solid and fills the preponderance of the chamber volume. New fluid introduced to cavity pushes through the solid in “worm holes”. Within an hour new fluid cannot successfully “worm” through the solid mass enough to return to its ink container and thus considerable leakage begins and very soon thereafter massive leaking occurs and the process must be shut down and cleaned out. Conventional chambers such as this and generally available in the market today have volumes of 2000-5000 millimeters per meter of chamber length. This is much too large a volume to keep all fluid in motion as required by the present invention. This design further allows more volume of fluid to be aerated per unit of time than does the preferred cavity.

It is clear that traditionally large volume chambers do not provide for maintaining uniform full chamber volume recirculation that is critical to keeping all fluid in motion, thereby allowing the benefit of controlling the shear rate above the minimum necessary to keep overall viscosity low. It is difficult to measure the real force necessary to pinpoint the requisite minimum shear because each pigment behaves somewhat differently. Influences such as ionic attraction forces, physical particle geometries, particle asperity, Van der Waals forces and the like can have significant affects on the overall rheology and behavior of the fluids. It is impractical to have individually designed cavities for each separate ink or fluid.

Another design is shown in FIG. 7 which shows a reduced size conventional chamber 36B. This design utilizes a conventional chamber that was reduced to a volume similar to the chamber of FIG. 6 above. Testing showed a clear tendency for the fluid to exhibit streaks and flow lines generally referred to as “streaks”, “starvation” or “spotting”. Flow rate to reduce this problem produces internal cavity pressures sufficient to cause slight to moderate leaking and “spitting”. Distribution across the length of the chamber and flow to exit ports is more difficult due to volume restrictions. This is clearly superior to the large volume conventional chambers but performs less well than the preferred version.

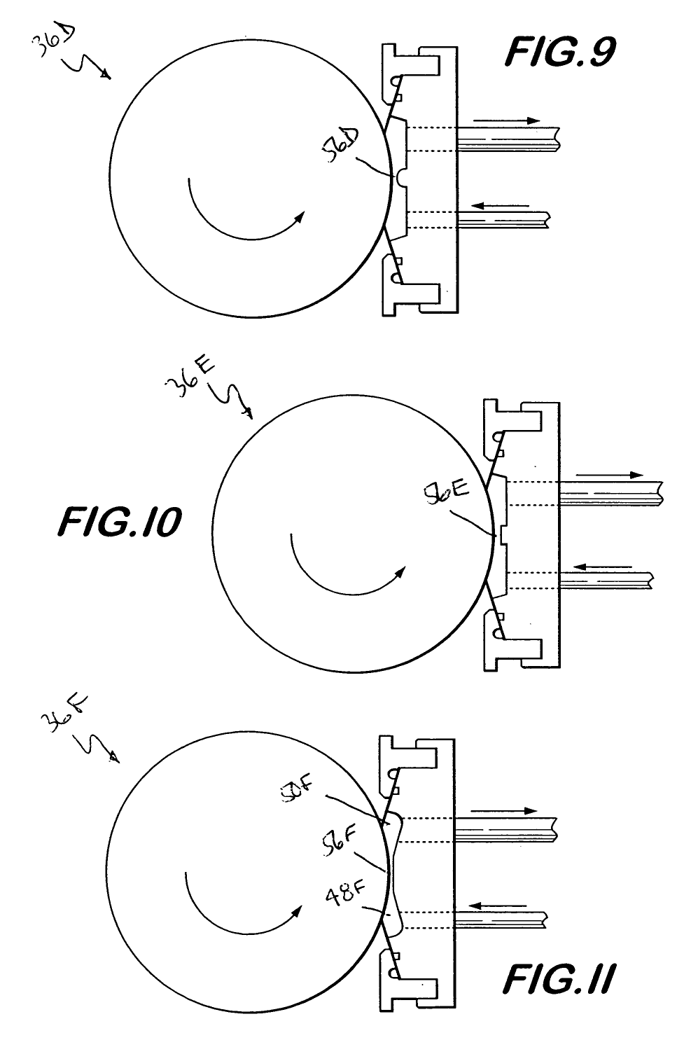

Two additional designs for chambers 36C, 36D and 36E are shown in FIGS. 8, 9 and 10, respectively. These versions are quite similar to the preferred version illustrating modifications to their pressure zones 56C, 56D and 56E. In general the rounded versions are more expensive to machine or require the use of inserts. The volumes of the chambers 36C, 36D and 36D tend to increase and thereby tend to suffer more stagnant areas that result in leaking and streaking problems more quickly than the preferred version. Color densities are not as stable as the wide flat shown in the preferred version but are improved versus the Reduced Conventional Cavity. Cleaning of these cavities will be somewhat more problematic than the preferred cavity because flow is not as active throughout the entire volume.

Finally, as shown in FIG. 11, a chamber 36F is shown having a parabolic shaped supply zone 48F and parabolic shaped return zone 50F. This cavity shape will work operate, but has tendency to show “streaking” or “starvation” lines and spots. “Spitting” through the interface of the blades-to-anilox intersection may also occur because of high pressure in the larger volume segment of the channels of the chamber being necessary for distribution across the length of the chamber of the ink or fluid.

Machining of this shape is also more difficult and time consuming to create than in the preferred version with no real additional benefit that is realized. The tenet of substantially reduced volume is met and active fluid behavior will be realized along with the other benefits. There will be a tendency for this geometry to develop more hydraulic pressure than the preferred version and therefore more chamber-to-anilox pressure will be required to hold the chamber to the anilox roll surface to allow for effective metering and containment of the ink or fluid.

While the invention has been described in detail and with reference to specific embodiments thereof, it will be apparent to one skilled in the art that various changes and modifications can be made therein without departing from the spirit and scope thereof.

What is claimed is

1. An ink supply system for coating an engraved surface of a coating cylinder of a printing press with an ink having high thixotropic fluid characteristics, comprising:
(A) a printing coating head, comprising:
(i) a main body having a longitudinal chamber for liquid extending for a length parallel to a longitudinal axis of the coating cylinder, open to said coating cylinder and having a seal to substantially seal the main body to the coating cylinder, said chamber comprising
(a) a supply zone to provide for ink distribution across the entire longitudinal chamber, said supply zone having a surface spaced from the engraved surface of the coating cylinder, the supply zone having a sufficiently small volume such that substantially all ink contained in the supply zone during operation of the ink supply system is kept in constant motion;
(b) a return zone having a surface spaced from the engraved surface of the coating cylinder, the return zone having a sufficiently small volume such that substantially all ink contained in the return zone during operation of the ink supply system is kept in constant motion; and
(c) a pressure zone having a face located substantially closer to the engraved surface than the surfaces of the supply zone and the return zone;
(ii) said main body having an inlet to provide liquid to a supply zone of the chamber;
(iii) said main body having an outlet to provide for liquid and air to move out of a return zone of the chamber;
(B) an ink container having an agitator disposed therein and an exit port at the bottom of the container
(C) a first pump to supply ink from the ink container to the supply zone of the chamber;
(D) a second pump to return ink from the return zone of the chamber to the ink container;
(E) said first pump and said second pump providing movement and increased pressure to substantially all ink within the chamber;
whereby substantially all ink within the system is kept at an increased pressure relative to ambient pressure and moving at all times to prevent substantially all stagnation of the ink within the system.

2. The ink supply system of claim 1, wherein the face of the pressure zone is located less than about 0.25 inches from the surface of the engraved roll.

3. The ink supply system of claim 1, wherein the face of the pressure zone is located between about 0.140 inches and about 0.050 inches from the surface of the engraved roll.

4. The ink supply system of claim 1, wherein the agitator extends to substantially the entire inside perimeter of the container.

5. The ink supply system of claim 1, wherein the agitator is of a propeller type design having blades.

6. The ink supply system of claim 1, wherein the blades extend to the inside perimeter of the container.

7. The ink supply system of claim 5, wherein the agitator has a rotational speed of between about fifty and one hundred fifty revolutions per minute.

8. The ink supply system of claim 5, wherein the agitator has a rotation speed sufficiently low to prevent cavitation of the ink.

9. The ink supply system of claim 1, wherein the supply zone is adapted to provide for ink distribution across the length of the longitudinal chamber, said surface of the supply zone being semi-circular in cross section and perpendicular to the length of the longitudinal chamber, said surface spaced from the engraved surface of the coating cylinder.

10. The ink supply system of claim 1, wherein the return zone is adapted to receive ink from the pressure zone and is disposed parallel to the supply zone, said surface of said return zone being semi-circular in cross section and perpendicular to the length of the longitudinal chamber, said surface spaced from the engraved surface of the coating cylinder.

11. The ink supply system of claim 1, wherein the first pump and the second pump are positive displacement pumps.

12. The ink supply system of claim 1, wherein the volume of the chamber is about 200 to 700 milliliters per meter of chamber length.

13. The ink supply system of claim 1, wherein the volume of the chamber is about 300 to 400 milliliters per meter of chamber length.

14. The ink supply system of claim 1, wherein the volume of the chamber is about 350 milliliters per meter of chamber length.

15. An ink supply system for coating an engraved surface of a coating cylinder of a printing press with an ink having high thixotropic fluid characteristics, comprising:
(A) a printing coating head, comprising:
(i) a main body having a longitudinal chamber for liquid extending for a length parallel to a longitudinal axis of the coating cylinder, open to said coating cylinder and having a seal to substantially seal the main body to the coating cylinder, said chamber comprising
(a) a supply zone to provide for ink distribution across the length of the longitudinal chamber, said supply zone having a surface spaced from the engraved surface of the coating cylinder, the supply zone having a sufficiently small volume such that substantially all ink contained in the supply zone during operation of the ink supply system is kept in constant motion, said surface of the supply zone being semi-circular in cross section and perpendicular to the length of the longitudinal chamber;
(b) a return zone parallel to the supply zone having a surface spaced from the engraved surface of the coating cylinder, the return zone having a sufficiently small volume such that substantially all ink contained in the return zone during operation of the ink supply system is kept in constant motion, said return zone being semi-circular in cross section and perpendicular to the length of the longitudinal chamber; and
(c) a pressure zone having a face located less than 0.25 inches from the engraved surface than the surfaces of the supply zone and the return zone;
(ii) said main body having an inlet to provide liquid to the supply zone of the chamber;
(iii) said main body having an outlet to provide for liquid and air to move out of the return zone of the chamber;
(B) an ink container having an agitator disposed therein and an exit port at the bottom of the container;
(C) a first pump to supply ink from the ink container to the supply zone of the chamber;
(D) a second pump to return ink from the return zone of the chamber to the ink container;
(E) said first pump and said second pump providing movement and increased pressure to substantially all ink within the chamber;
whereby substantially all ink within the system is kept at an increased pressure relative to ambient pressure and moving at all times to prevent substantially all stagnation of the ink within the system.

16. The ink supply system of claim 15, wherein the face of the pressure zone is located between about 0.140 inches and about 0.050 inches from the surface of the engraved roll.

17. The ink supply system of claim 15, wherein the agitator extends to substantially the entire inside perimeter of the container.

18. The ink supply system of claim 15, wherein the agitator is of a propeller type design having blades.

19. The ink supply system of claim 15, wherein the blades extend to the inside perimeter of the container.

20. The ink supply system of claim 18, wherein the agitator has a rotational speed of between about fifty and one hundred fifty revolutions per minute.

21. The ink supply system of claim 18, wherein the agitator has a rotation speed sufficiently low to prevent cavitation of the ink.

22. The ink supply system of claim 15, wherein the first pump and the second pump are positive displacement pumps.

23. The ink supply system of claim 15, wherein the volume of the chamber is about 200 to 700 milliliters per meter of chamber length.

24. The ink supply system of claim 15, wherein the volume of the chamber is about 300 to 400 milliliters per meter of chamber length.

25. The ink supply system of claim 15, wherein the volume of the chamber is about 350 milliliters per meter of chamber length.
